(19) United States
(12) Patent Application Publication
(10) Pub. No.: US 2011/0258308 A1
(43) Pub. Date: Oct. 20, 2011

(54) SYSTEM AND METHOD FOR DEDUCING PRESENCE STATUS FROM NETWORK DATA

(75) Inventors: Thangavelu Arumugam, San Jose, CA (US); Ashutosh A. Malegaonkar, Milpitas, CA (US); Supriya Kher, Santa Clara, CA (US)

(73) Assignee: Cisco Technology, Inc.

(21) Appl. No.: 12/762,194

(22) Filed: Apr. 16, 2010

(51) Int. Cl. G06F 15/173

(52) U.S. Cl. 709/224

(57) ABSTRACT

An example method includes receiving network traffic associated with an end user and evaluating the network traffic to identify network activity associated with the end user. The method includes generating a presence status associated with the end user based on the network activity, the presence status is deduced automatically without involving active participation from the end user. In more specific embodiments, the presence status is integrated into a directory in which presence status for a plurality of end users is stored. Initially, the end user can be marked in an unavailable state, where authentication to a network causes the presence status to change to an available state. In other embodiments, calendar events and telephone events can be tracked for the end user in order to update the presence status. Additionally, at least one parameter associated with the presence status is hidden based on configurable end user privacy preferences.

### TECHNICAL FIELD

This disclosure relates in general to the field of communications and, more particularly, to deducing presence status from network data.

### BACKGROUND

The field of communications has become increasingly important in today's society. In particular, the ability to effectively gather, associate, and organize information presents a significant obstacle for component manufacturers, system designers, and network operators. This obstacle is made even more difficult due to privacy issues, which seem ubiquitous in today's corporate environments. As new communication platforms and technologies become available, new protocols should be developed in order to optimize the use of these emerging protocols. Some issues have arisen in data monitoring scenarios in which content (sought to be intelligently evaluated) propagates in the network.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for deducing presence status from network data in accordance with one embodiment of the present disclosure;

FIG. 2 is a simplified block diagram of a network presence engine in accordance with one embodiment of the present disclosure;

FIG. 3 is a simplified block diagram of a server configuration in accordance with one embodiment of the present disclosure;

FIG. 4 is a simplified block diagram of another server configuration in accordance with one embodiment of the present disclosure;

FIG. 5 is a simplified block diagram of a network presence state configuration in accordance with one embodiment of the present disclosure; and

FIG. 6 is a simplified flowchart in accordance with one embodiment of the present disclosure.

### DETAILED DESCRIPTION OF EXAMPLE EMBODIMENTS

### Overview

A method is provided in one example and includes receiving network traffic associated with an end user and evaluating the network traffic in order to identify network activity associated with the end user. The method further includes generating a presence status associated with the end user based on the network activity, the presence status is deduced automatically without involving active participation from the end user. In more specific embodiments, the presence status is integrated into a directory in which presence status for a plurality of end users is stored. Initially, the end user can be marked in an unavailable state, where authentication to a network causes the presence status of the end user to change to an available state.

In still other embodiments, a first time interval is configured such that if the first time interval expires and the network activity is not identified during the first time interval, the presence status changes to an away state for the end user. In other embodiments, a second time interval can be configured such that if the second time interval expires and the network activity is not identified during the second time interval, the presence status changes to an unavailable state for the end user. Calendar events and telephone events can be tracked for the end user in order to update the presence status. In yet other embodiments, at least one parameter associated with the presence status of the end user is hidden based on configurable end user privacy preferences.

### Example Embodiments

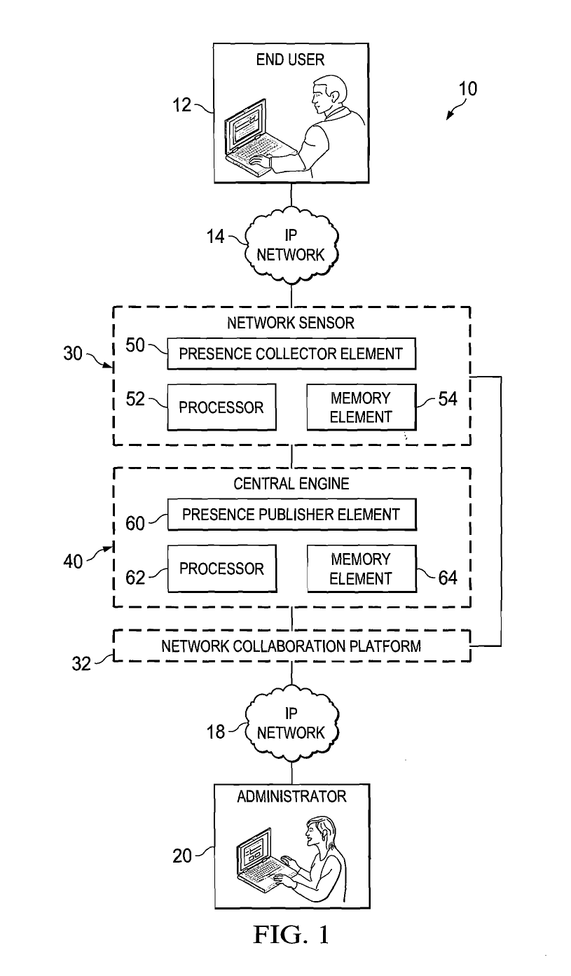

FIG. 1 is a simplified block diagram of a communication system 10 for deducing presence status from network activity in accordance with one embodiment. FIG. 1 may include an end user 12, who is operating a computer device that is configured to interface with an Internet Protocol (IP) network 14. In addition, an administrator 20 is provided, where administrator 20 has the ability to interface with the architecture through an IP network 18. FIG. 1 may also include a network sensor 30, which may include a presence collector element 50, a processor 52, and a memory element 54. Communication system 10 may further include a network collaboration platform (NCP) 32 and a central engine 40, which may include a presence publisher element 60, a processor 62, and a memory element 64. Multiple network sensors 30 and/or central engines 40 may be provisioned at various places within the network, where such provisioning may be based on the presence activity information sought to be collected, the capacity of various network elements, the number of individuals having their presence status being tracked, etc.

Before turning to the example flows of the present disclosure, it is important to understand the communications that may be traversing the network and that can be used to track presence data for given individuals. In computer and telecommunications networks, presence information can offer a status indicator, which conveys an ability and/or a willingness of a potential user to communicate with another user. A user's client application can provide presence information (e.g., presence preferences) via a network connection to a presence service. The presence state can be stored as a personalized availability record (commonly referred to as “presentity”). This presentity can be made available for distribution to other users (e.g., watchers, inquirers, colleagues, etc.) for conveying his availability for possible communications.

This protocol of identifying user availability by explicitly changing a status of the client application can be problematic. For example, there is considerable overhead in making these changes and, further, such protocols typically require a given individual to actively register, manage, and (often) manually change his presence information. For example, some systems can require a user to manually set his activity status: often requiring the user to log into his client application, modify his status to available, away, busy, etc., and continually update his status. This creates needless overhead for the individual users that seek to advertise their individual presence status to others.

In contrast to these limited operations, communication system 10 can uniformly and intelligently identify the presence status for specific end users without requiring their active involvement. Communication system 10 can be configured to deduce presence parameters associated with a targeted individual. Communication system 10 can automatically and systematically deduce (i.e., construe, interpret, understand, infer, etc.) the user's presence status based on his network activities (i.e., by evaluating and/or inspecting his network traffic). For example, in one possible implementation scenario, there could be three possible states for classifying end users: 1) online/active; 2) away/inactive; and 3) offline. Additionally, these states could be further developed to offer richer modes of activity details. Other possible implementation scenarios are further discussed below, where different modes (and different possible state classifications) are described.

User states can be effectively inferred in various ways. For example, if the network detects e-mail user activity (via network traffic), communication system 10 could mark the associated user as being active. If the network does not detect any traffic for a predetermined time, then the user could be marked in an away status. Communication system 10 could also be configured to bump a state to an inactive status, if traffic is not seen for a predetermined inactive time period. Additionally, each individual user may be offered privacy settings (i.e., preferences) to choose which presence parameters will ultimately be shared with (or hidden from) other users. Offering even more granularity, communication system 10 can be used to develop particular communities, or groups of users such that specific presence status parameters would only be available to designated groups of individuals. More than simply detecting a preferred method of contact, communication system 10 can be configured to automatically evaluate network activity to be used in intelligently mapping these activities to an appropriate status (e.g., active, inactive, offline, etc.). Instead of implementing a rigid, rule-based presence protocol, communication system 10 can use actual network activity to generate an appropriate presence status to be conveyed to other interested users.

In regards to advantages in such a configuration, unlike having multiple clients with varying presence status (which can be misleading/confusing to other users, and which often requires significant manual input), presence status can be automatically determined. Additionally, this presence status can be systematically updated, which offers a unified and a reliable protocol for conveying a user's presence status.

Furthermore, communication system 10 obviates the need for desktop client agents to track user activities. Communication system 10 can eliminate the need for multi-platform support, for installation, and for the maintenance of such arrangements. Additionally, other status solutions are commonly confined to server-based models, where a client application would be installed on each desktop for corresponding users being targeted for their presence status. In contrast, communication system 10 can be clientless in certain implementations discussed herein. Communication system 10 has the intelligence to inspect and/or to evaluate various sources of network traffic (e.g., including evaluating certain desktop applications, system information, software behavior, telephone exchanges (e.g., involving an IP phone, a land line, etc.), personal Telepresence characteristics, calendar and scheduling applications, etc.) to deduce network activities and subsequently generate (e.g., designate) the user's presence status. Further, communication system 10 enables unified communications to be utilized to their fullest, which includes identifying parameters such as click to call, click to Telepresence, click to Webex, etc. as being part of the network activities used to deduce presence status.

In operation, the architecture of communication system 10 can be configured to automatically analyze user traffic (e.g., periodically) in order to identify the presence status of a particular user. For example, e-mail activity could be used to deduce that a given user is available and, further, that he would be available on e-mail for the next thirty minutes, the next hour, until a meeting starts/ends, etc. (Any configurable time interval could be designated in such a scenario.) Note that the actual e-mails for this particular user are not being evaluated per se, but instead an inference is being made as to the presence status associated with this user. Similarly, hypertext transfer protocol (HTTP) traffic could be indicative of a user performing some task on the Internet. In such an instance, this particular user's presence status could be deduced as available, where a further deduction could reveal that he is in a meeting such that his presence status would advertise this condition.

All of this information can be collected by presence collector element 50. A certain number of presence collectors can be provisioned at various locations such that these collectors can form a distributed configuration. All such presence collector elements 50 can interface with corresponding presence publisher elements 60. Presence publisher element 60 can maintain a table or a map (e.g., per user) in order to track the presence status for each individual. For example, presence publisher elements 60 could have an entry in a table that suggests that a particular user was last noted as being engaged in e-mail exchanges. Hence, this particular user could have an ‘available on e-mail’ status associated with him. In this sense, presence publisher element 60 can maintain/update states for each individual user and, further, readily convey this information to interested parties.

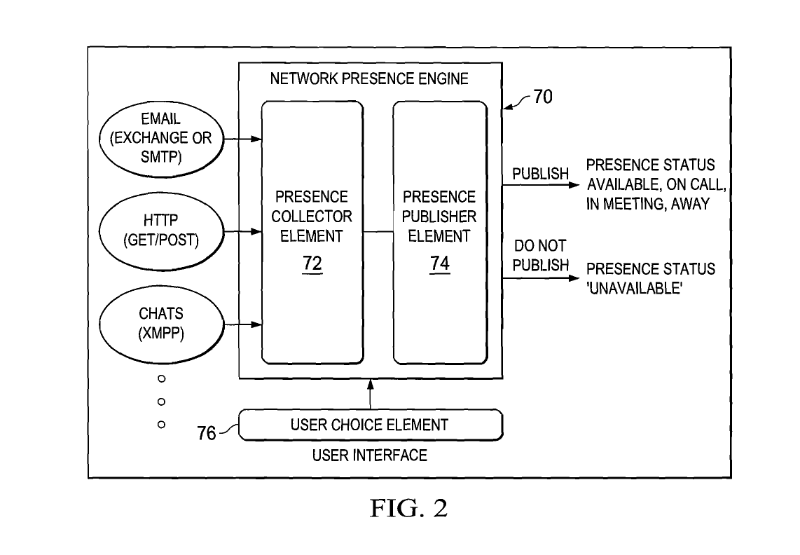

In one particular example, communication system 10 is configured to deduce the following possible user states: unavailable—the system is unaware of a user's network activity; available—the system learns this state when a user is actively sending out traffic in the network (i.e., exchanging emails, active on Chat or instant messaging, viewing/posting content over HTTP, etc.); on call—the system switches to this state when the user picks up the phone and issues a dial request that is successful; in meeting—the system retrieves calendar events for the user to determine the times when the user is busy (this could be used in conjunction with an Outlook Calendar, a scheduling application, a WebEx scheduling application, or a similar organizational mechanism); away—the system declares a user to be away when he is not generating traffic for a specific configurable timeout interval. Some of the other possible configurations are described below with reference to FIGS. 2-6.

Turning to the infrastructure of FIG. 1, IP networks 14 and 18 represent a series of points or nodes of interconnected communication paths for receiving and transmitting packets of information, which propagate through communication system 10. IP networks 14 and 18 offer a communicative interface between servers (and/or end users) and may be any local area network (LAN), a wireless LAN (WLAN), a metropolitan area network (MAN), a virtual LAN (VLAN), a virtual private network (VPN), a wide area network (WAN), or any other appropriate architecture or system that facilitates communications in a network environment. IP networks 14 and 18 can implement a TCP/IP communication language protocol in a particular embodiment of the present disclosure; however, IP networks 14 and 18 may alternatively implement any other suitable communication protocol for transmitting and receiving data packets within communication system 10.

Different types of data can flow through the architecture of communication system 10. Components within communication system 10 can identify which data should be processed by particular components of the configuration. For example, network sensor 30 can receive various pieces of data from end user 12 and, further, use this data to deduce presence status associated with end user 12. In one example embodiment, only a certain domain of data (e.g., types of data) is targeted for use in deducing presence status. As used herein in this Specification, the term ‘data’ is meant to encompass any information (video, text, audio, multimedia, voice, HTTP, telephone system information, calendar information, software application information or signaling, connectivity information, authentication information, etc.) in any suitable format that propagates in a network environment. The particular domain could be configured by administrator 20, by certain network elements (e.g., presence collector element 50), or by selected pieces of software as part of a set of default choices such that certain data can be evaluated for determining the presence status of particular individuals. Additionally, administrator 20 (or some network element, or some selected piece of software) can also identify and respect privacy issues configured by certain individuals. Hence, certain presence status parameters would not be shared amongst employees in a corporate (potentially public) environment, per the user's preferences, as detailed below.

Note that network sensor 30 and/or central engine 40 can readily be part of a server in certain embodiments of this architecture. In one example implementation, network sensor 30 and/or central engine 40 are network elements that facilitate or otherwise help coordinate the presence status operations, as explained herein. As used herein in this Specification, the term ‘network element’ is meant to encompass network appliances, servers, routers, switches, gateways, bridges, loadbalancers, firewalls, processors, modules, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

In one example implementation, network sensor 30 and/or central engine 40 include software (e.g., as part of presence collector element 50 and/or presence publisher element 60, etc.) to achieve the presence status identification operations, as outlined herein in this document. In other embodiments, these features may be provided externally to any of the aforementioned elements, or included in some other network device to achieve these intended functionalities. Alternatively, several elements may include software (or reciprocating software) that can coordinate in order to achieve the operations, as outlined herein. In still other embodiments, any of the devices of FIG. 1 may include any suitable algorithms, hardware, software, components, modules, interfaces, or objects that facilitate these presence status identification operations. Additional operational capabilities of communication system 10 are detailed below with respect to FIGS. 2-6.

Turning to FIG. 2, FIG. 2 is a simplified block diagram illustrating a network presence engine 70 in accordance with one embodiment of the present disclosure. This particular configuration can be representative of a network element (e.g., residing in a single component) for intelligently evaluating and tracking the presence status of a multitude of end users. Network presence engine 70 may include a presence collector element 72 and a presence publisher 74, which may be coupled to a user choice element 76 that can be associated with a user interface. Note that a number of activities are also shown in FIG. 2, and these activities can be used as a basis for deducing the user's presence status. In this particular arrangement, the activities are associated with e-mail, HTTP (get/post), chats (e.g., extensible messaging and presence protocol (XMPP)), etc. Other activities can certainly be used in order to identify the presence status associated with specific individuals, as FIG. 2 is outlining simply one possible implementation.

User choice element 76 is configured to allow each user to elect which presence options he would like to have published. This would give the user a privacy feature for his particular status parameters. Hence, if a presence status inquiry were made for a particular user who elected not to have his presence status made available, then a simple message would be communicated back to the inquiring individual that this user's particular presence status is “unavailable” or “private.” If the presence status for this individual were published, then any number of suitable responses would be returned to the inquiring individual (e.g., available, on call, in meeting, away, etc.). It is imperative to note that this example of FIG. 2 is merely representing one of the many possible configurations that network presence engine 70 could have. Other permutations are clearly within the broad scope of the tendered disclosure.

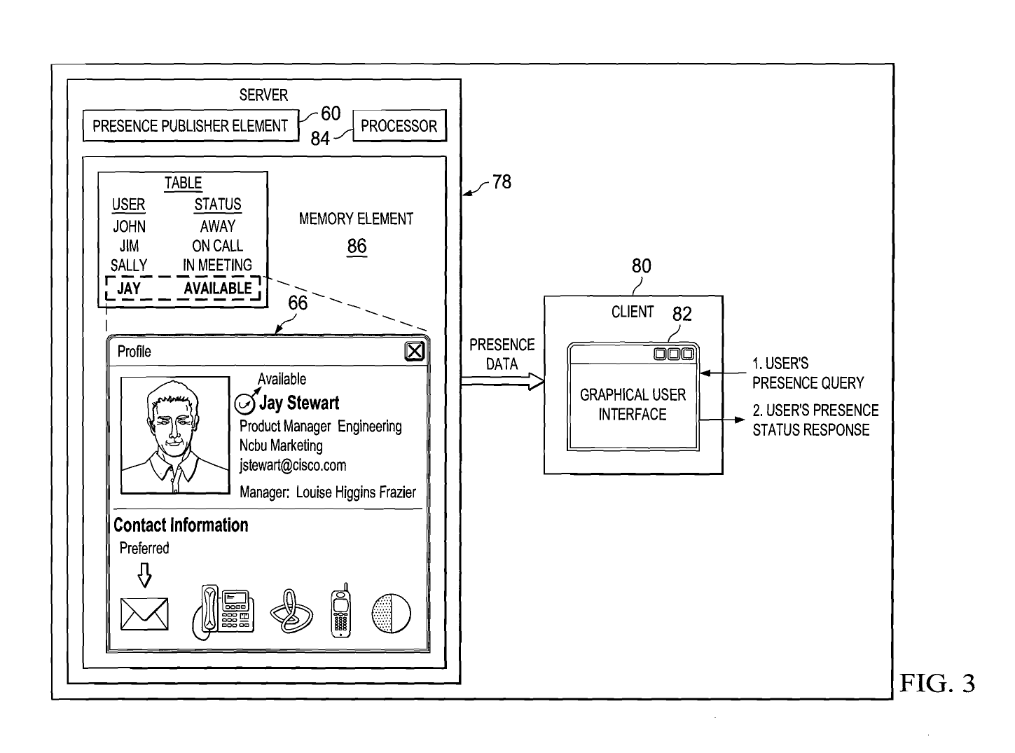

FIG. 3 is a simplified block diagram illustrating one possible configuration for communication system 10. This particular mode of operation relates to presence as a type of application. FIG. 3 includes a server 78, which further includes presence publisher element 60, a processor 84, and a memory element 86. Memory element 86 may further include a table, which shows a number of users along with their corresponding status. In this particular example, certain users have their status marked as: away, on call, or in a meeting. One particular user named Jay is available, where his preferred contact information 66 is displayed along with an available icon that can be conveyed to an inquiring individual (provided that Jay has elected to publish his presence status to other interested users).

Also provided in FIG. 3 is a client 80, which includes a graphical user interface (GUI) interface 82. Presence data can be communicated (e.g., pushed) from server 78 to client 80 in any appropriate manner (involving any suitable connection link, pathway, channel, etc.). Queries can be sent to GUI interface 82, where presence status responses can be generated and returned back to an inquiring individual. Hence, in this particular mode, server 78 could be used (e.g., in conjunction with an application) that collects or that otherwise processes presence data to show the status of particular users. This status information could be fed to client 80 such that the client can intelligently respond to queries associated with the user's presence data. In one particular example, GUI interface 82 can be used to facilitate this interaction.

In operation, and as illustrated in FIG. 3, at step one, a simple presence query can be received by client 80. The presence information delivered by server 78 would empower client 80 to respond to this query at step two. In this particular example, GUI interface 82 responds with the user's presence status such that the issuer of the query can identify the best available way to contact this particular individual.

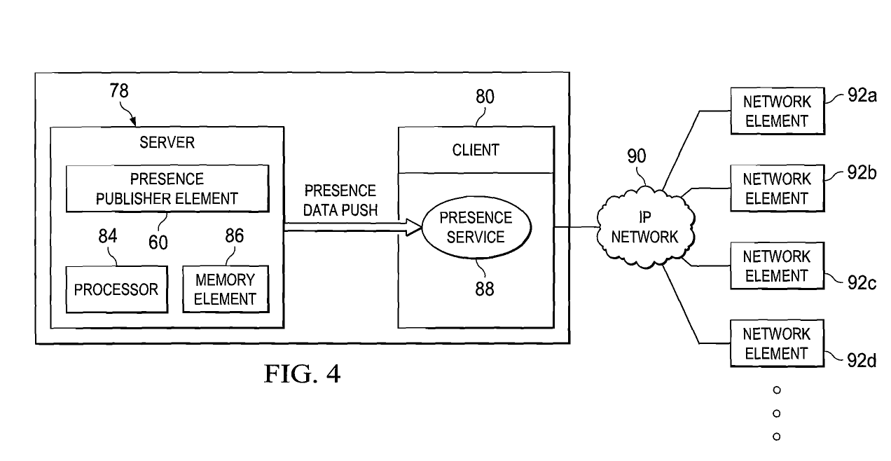

FIG. 4 is a simplified block diagram illustrating another possible configuration for communication system 10. This particular mode of operation relates to presence as a service function. FIG. 4 includes a presence service 88 being configured on client 80. Presence service 88 may coupled to an IP network 90, which has connections to various types of network elements 92a-d. Network elements 92a-d can represent any type of network device, appliance, proxy, or component that is seeking to retrieve presence status associated with particular individuals. In this particular service mode, server 78 can use presence publisher element 60 to deliver presence data to any interested network element 92a-d. Note that because the architecture operates on the network, presence data can be offered to various components that query for such information. Any application that seeks to make use of presence data can simply issue a query (e.g., using an application program interface (API)).

In one example implementation, presence service 88 can be part of a directory application (e.g., as part of a database) such that the status of many users could be identified quickly. Thus, network presence can be integrated with the enterprise directory such that it becomes a single unified location for retrieving presence status. This would eliminate the need for having multiple applications that deduce a user's presence status.

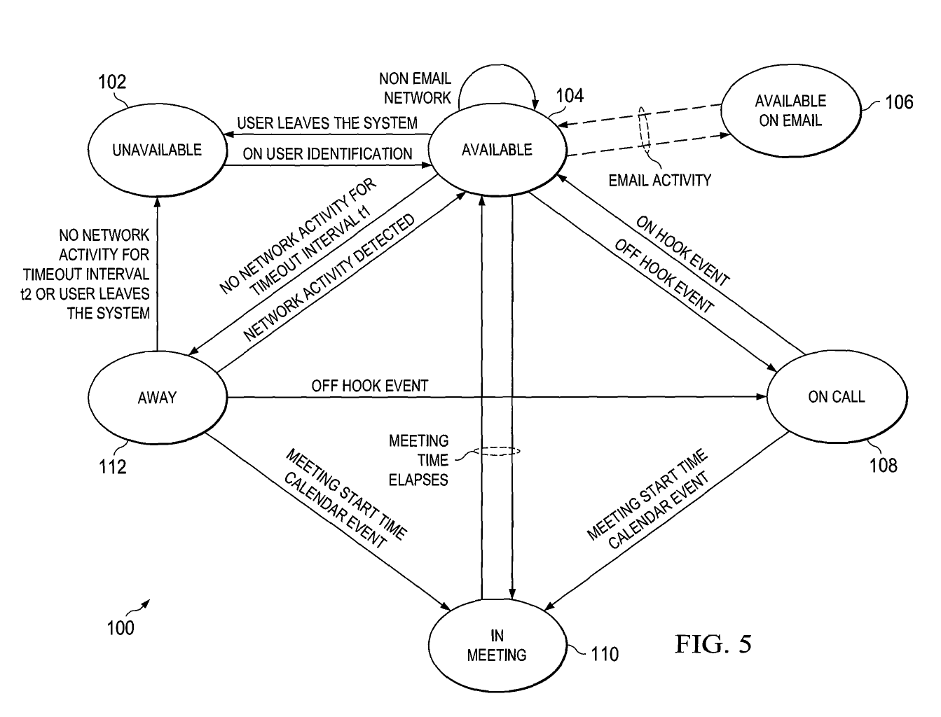

FIG. 5 is a simplified block diagram of a network presence state configuration 100 for providing the presence status associated with multiple individuals. FIG. 5 includes an unavailable status 102, an available status 104, an available on e-mail status 106, an on call status 108, an in meeting status 110, and an away status 112. Note that this list is not exhaustive, as it simply represents one scheme for possibly classifying the presence status for particular users. Other schemes can certainly be configured or arranged and, further, can offer particular presence status indicators, or different status labels, tailored for particular scenarios.

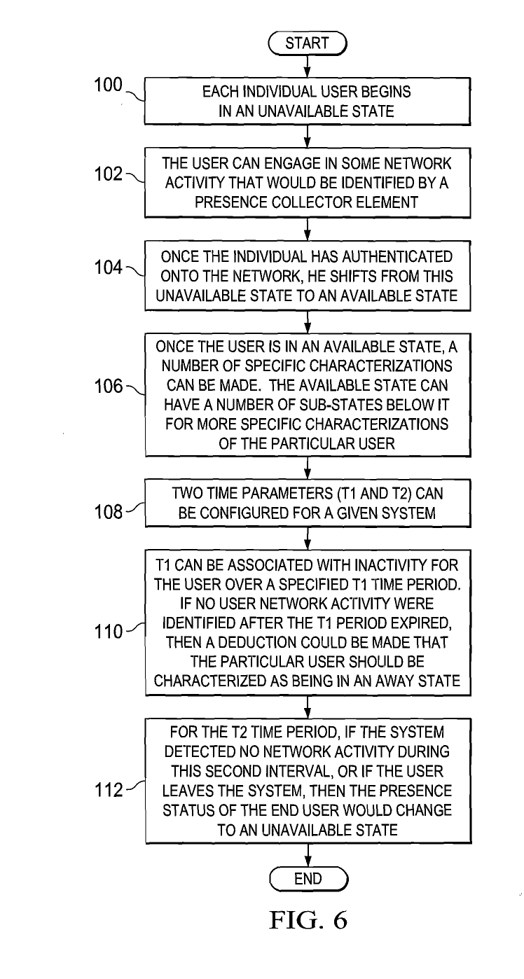

FIG. 6 is discussed in conjunction with FIG. 5, as it represents a simplified parallel flowchart in accordance with an embodiment of the present disclosure. FIGS. 5-6 are related in their operations and, as such, they are discussed together. In one particular example, each individual user begins in an unavailable state (shown as step 100 in FIG. 6). Subsequently, the user can engage in some network activity that would be identified by a presence collector element (shown in step 102 of FIG. 6). For example, once the individual has authenticated onto the network, he could shift from this unavailable state to an available state (shown in step 104 of FIG. 6). Once the user is in an available state, a number of specific characterizations can be made. Stated otherwise, the available state can have a number of sub-states below it for more specific characterizations of the particular user. For example, the user could be classified as being in an away state, or being on call, or being in a meeting, or only available via certain protocols (e.g., e-mail, instant messaging, text, etc.). This is shown in step 106 of FIG. 6.

Note that system information can also be gleaned by this architecture. This would allow on hook and off hook events (i.e., telephone events) to be noted and incorporated into the presence analysis for accurately characterizing the user's presence status. In other examples, network activity such as calendar events (i.e., meeting times, starting times for various calendared events, meeting time elapses, etc.), connections or disconnections to particular applications, servers, networks, etc. can be used to assist in deducing an individual's presence status. Other parameters could readily be incorporated into this analysis and, further, be based on the particular needs of the individuals.

In one particular example, two time parameters (T1 and T2) can be configured for a given system (shown in step 108 of FIG. 6). For example, T1 can be associated with inactivity for the user over a specified T1 time period. If no user network activity were identified after the T1 period expired, then a deduction could be made that the particular user should be characterized as being in an away state (shown in step 110 of FIG. 6). For the T2 time period, if the system detected no network activity during this second interval, or if the user leaves the system (e.g., logs out, disconnects from the network, etc.), then the presence status of the end user would change to an unavailable state. This is shown in step 112 of FIG. 6.

Software for providing intelligent presence status evaluation can be provided at various locations within communication system 10. In one example implementation, software can be resident in a network element, such as in central engine 40 and/or in network sensor 30, or in another network element for which this capability is relegated. In other examples, this could involve combining central engine 40 and/or network sensor 30 in an application server or a gateway, or in some proprietary element, which could be provided with (or be proximate to) these identified network elements, or this could be provided in any other device being used in a given network. In one specific instance, central engine 40 provides the presence publisher features explained herein, while network sensor 30 can be configured to offer the presence collector activities detailed herein. In such an implementation, network sensor 30 can initially receive the user data (or system behavior), employ certain filtering or processing to determine the presence status, and then send that presence status information to central engine 40 to further develop, or otherwise publish, the presence status.

In other embodiments, the presence collecting feature may be provided externally to network sensor 30, or included in some other network device, or in a computer to achieve these intended functionalities. As identified previously, a network element can include software to achieve the presence status identification operations, as outlined herein in this document. In certain example implementations, the presence status identification functions outlined herein may be implemented by logic encoded in one or more tangible media (e.g., embedded logic provided in an application specific integrated circuit [ASIC], digital signal processor [DSP] instructions, software [potentially inclusive of object code and source code] to be executed by a processor, or other similar machine, etc.).

In some of these instances, a memory element [as shown in FIGS. 1, 3-4] can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor [as shown in FIGS. 1, 3-4] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving the presence status identification operations as outlined herein. Additionally, each of these devices may include a processor that can execute software or an algorithm to perform the presence status identification activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein (e.g., a table, a database, a repository, etc.) should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that with the examples provided herein, interaction may be described in terms of two, three, four, or more network elements. However, this has been done for purposes of clarity and example only. In certain cases, it may be easier to describe one or more of the functionalities of a given set of flows by only referencing a limited number of components or network elements. It should be appreciated that communication system 10 of FIG. 1 (and its teachings) are readily scalable. Communication system 10 can accommodate a large number of components, as well as more complicated or sophisticated arrangements and configurations. Accordingly, the examples provided should not limit the scope or inhibit the broad teachings of communication system 10 as potentially applied to a myriad of other architectures.

It is also important to note that the steps described with reference to the preceding FIGURES illustrate only some of the possible scenarios that may be executed by, or within, communication system 10. Some of these steps may be deleted or removed where appropriate, or these steps may be modified or changed considerably without departing from the scope of the discussed concepts. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the discussed concepts.

What is claimed is:

1. A method, comprising:
receiving network traffic associated with an end user;
evaluating the network traffic in order to identify network activity associated with the end user; and
generating a presence status associated with the end user based on the network activity, wherein the presence status is deduced automatically without involving active participation from the end user.

2. The method of claim 1, wherein the presence status is integrated into a directory in which presence status for a plurality of end users is stored.

3. The method of claim 1, wherein the end user is marked in an unavailable state initially, and wherein authentication to a network causes the presence status of the end user to change to an available state.

4. The method of claim 1, wherein a first time interval is configured such that if the first time interval expires and the network activity is not identified during the first time interval, the presence status changes to an away state for the end user.

5. The method of claim 4, wherein a second time interval is configured such that if the second time interval expires and the network activity is not identified during the second time interval, the presence status changes to an unavailable state for the end user.

6. The method of claim 1, wherein calendar events and telephone events are tracked for the end user in order to update the presence status.

7. The method of claim 1, wherein at least one parameter associated with the presence status is hidden based on configurable end user privacy preferences.

8. Logic encoded in one or more tangible media that includes code for execution and when executed by a processor is operable to perform operations comprising:
receiving network traffic associated with an end user;
evaluating the network traffic in order to identify network activity associated with the end user; and
generating a presence status associated with the end user based on the network activity, wherein the presence status is deduced automatically without involving active participation from the end user.

9. The logic of claim 8, wherein the presence status is integrated into a directory in which presence status for a plurality of end users is stored.

10. The logic of claim 8, wherein the end user is marked in an unavailable state initially, and wherein authentication to a network causes the presence status of the end user to change to an available state.

11. The logic of claim 8, wherein a first time interval is configured such that if the first time interval expires and the network activity is not identified during the first time interval, the presence status changes to an away state for the end user.

12. The logic of claim 11, wherein a second time interval is configured such that if the second time interval expires and the network activity is not identified during the second time interval, the presence status changes to an unavailable state for the end user.

13. The logic of claim 8, wherein calendar events and telephone events are tracked for the end user in order to update the presence status.

14. The logic of claim 8, wherein at least one parameter associated with the presence status is hidden based on configurable end user privacy preferences.

15. An apparatus, comprising:
a memory element configured to store data;
a processor operable to execute instructions associated with the data;
a network sensor configured to interface with the memory element and the processor, the network sensor being configured to:
receive network traffic associated with an end user; and
evaluate the network traffic in order to identify network activity associated with the end user, wherein a presence status associated with the end user is generated based on the network activity, and wherein the presence status is deduced automatically without involving active participation from the end user.

16. The apparatus of claim 15, wherein the presence status is integrated into a directory in which presence status for a plurality of end users is stored.

17. The apparatus of claim 15, wherein a first time interval is configured such that if the first time interval expires and the network activity is not identified during the first time interval, the presence status changes to an away state for the end user.

18. The apparatus of claim 17, wherein a second time interval is configured such that if the second time interval expires and the network activity is not identified during the second time interval, the presence status changes to an unavailable state for the end user.

19. The apparatus of claim 15, wherein calendar events and telephone events are tracked for the end user in order to update the presence status.

20. The apparatus of claim 15, wherein at least one parameter associated with the presence status is hidden based on configurable end user privacy preferences.
